(19) United States
(12) Patent Application Publication
(10) Pub. No.: US 2010/0219099 A1
(43) Pub. Date: Sep. 2, 2010

(54) Secure package for multiple transaction cards

(76) Inventors: Stephen E. Schmitt, Winnetka, IL (US); Mark Rosland, Westmont, IL (US); Robert Federico, Louisville, KY (US); Thomas Hughes, Buffalo Grove, IL (US)

Correspondence Address: Susan Schmitt, 1433 Great Heron Dr., Santa Rosa, CA, 95409, US

(21) Appl. No.: 12/658,303

(22) Filed: Feb. 9, 2010

Related U.S. Application Data
(60) Provisional application No. 61/207,462, filed on Feb. 12, 2009.

(51) Int. Cl. B65D 25/54; A45C 11/18; B65B 1/04; G06K 5/00; G06K 19/06

(52) U.S. Cl. 206/776; 206/39; 53/473; 235/380; 235/494

(57) ABSTRACT

A package assembly, assembly and/or manufacturing method and packaging system, is provided for example including but not limited to gift cards, telephone service cards, music download cards, on-line purchase cards, ATM cards or the like.

### FIELD OF THE INVENTION

This invention relates generally to the packaging, display, and security of debit cards activated at the point of sale.

### BACKGROUND OF THE INVENTION

Within the last three decades there has been a revolution in the use of plastic cards. Gift cards are used for payment in many retail situations. In retail stores, for telephone services, for on-line purchases, for music downloads, and for ATM usage.

### SUMMARY OF THE INVENTION

This invention is directed towards a package assembly, assembly and/or manufacturing method and packaging system, including but not limited to, for example, gift cards, telephone service cards, music download cards, on-line purchase cards, ATM cards or the like.

### BRIEF DESCRIPTION OF THE DRAWINGS

FIG. 1 is a perspective view of a variation of a package containing an assembly of transaction cards

FIG. 2 is a perspective view of the assembly of transaction cards of FIG. 1

FIG. 3 is a side view of a variation of a package containing an assembly of transaction cards.

FIG. 4 is a side view of a variation of a package containing an assembly of transaction cards.

FIG. 5 is a perspective view of the reverse side of a package containing an assembly of transaction cards.

FIG. 6 is a plan view of a variation of a transaction card.

FIG. 7 is a plan view of a variation of a transaction card.

FIG. 8 is a perspective view of a package containing an assembly of transaction cards.

FIG. 9 is a perspective view of the inner assembly of FIG. 8.

FIG. 10 is a perspective view of a variation of a package containing an assembly of transaction cards.

### DETAILED DESCRIPTION OF THE INVENTION

In an effort to make the purchase of gift cards, telephone service cards, music download cards, on-line purchase cards, ATM cards or the like easier, many retailers desire to package multiple cards in a single package which can be activated with a single point of sale transaction. Consumers wish to buy multiple cards conveniently.

Several packaging alternatives exist but all have limitations and flaws. One common package is a clam shell blister pack. This package has the benefit that cards are visible but are not as secure from tampering. Criminals can disassemble the package by opening the clam shell and can tamper with transactions cards and steal valuable data.

Other blister pack alternatives exist but have similar problems with tamper resistance. In addition, the blister alternatives are very bulky which makes them less attractive to consumers and to retailers who would like to place as many pieces on a display rack as possible. The blister in all blister pack alternatives does not secure the cards fully requiring the use of multiple placements of fugitive glue on card surfaces to secure the cards to the carrier and to each other. It is inconvenient to the consumer to remove the glue from multiple surfaces and dispose of it. On all blister alternatives, the blister requires a flange area of typically ¼″ around the perimeter of the blister. The flange is required to secure the blister to heat seal adhesive that has been applied to the carrier card. Required flanges necessary to secure the blister to the carrier card occupy space that could be used for attractive marketing information. The blister flanges also expand the necessary overall size of the blister package making it more difficult to fit in limited retail display space.

Some embodiments of the invention are directed towards an assembly methodology and a completed package that is a thinner, more secure, more attractive, and more efficient with more recyclable materials.

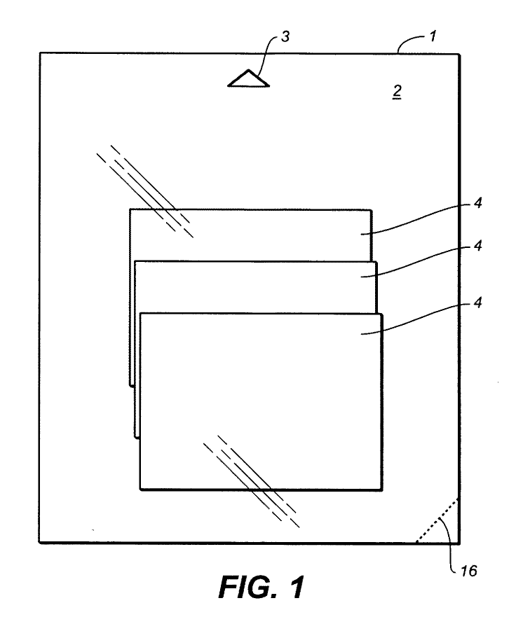

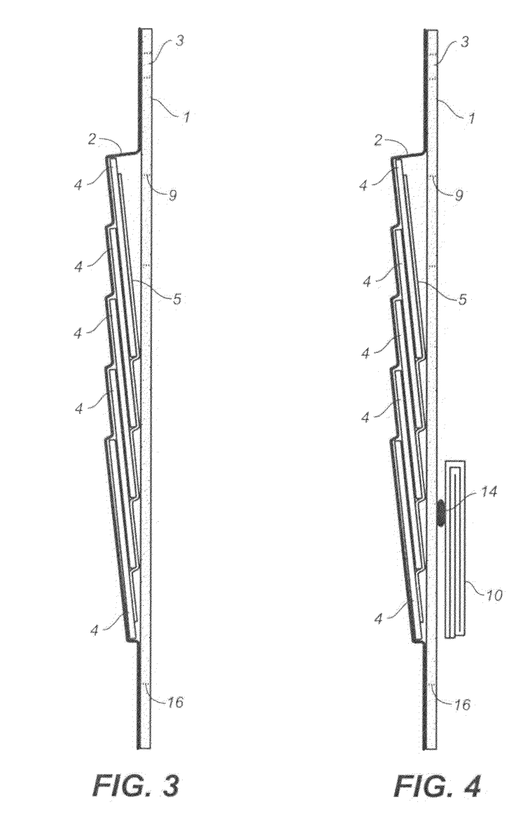

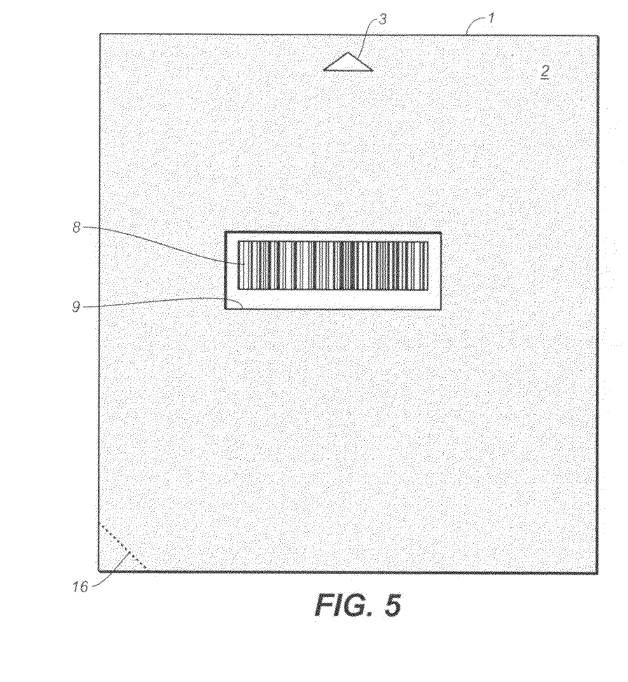

Referring to the drawings, FIG. 1 is a perspective view of a package containing an assembly of cards according to some embodiments of the invention. The package portion includes a carrier sheet 1 which has been coated with a heat reactive adhesive commonly used for blister packaging and die cut with the activation bar code window 9 (FIG. 5) with a clear cover sheet 2 adhered to the surface by heating the clear cover sheet 2 and impressing it onto the surface of the carrier sheet 1. The clear cover sheet is translucent or substantially transparent so that the cards 4 may be viewed through the clear cover sheet 2. The clear cover sheet 2 is heated to nearly its melting point where it is very flexible and then lowered over the carrier sheet 1 and the transaction cards 4. A vacuum is drawn through the carrier sheet 1 evacuating the air between it and the clear cover sheet 2 and conforming the clear cover sheet 2 tightly to both the transaction cards 4 and the carrier sheet 1 as shown in FIG. 3. When the clear cover sheet 2 cools it bonds tightly to the carrier sheet 1. Any tampering or pulling of the clear cover sheet 2 will be evident by torn fibers or damaged providing security to blister packaging or folded and glued carriers typically used to packaging transaction cards. After the clear cover sheet is adhered a hanging hole 3 in any variety of shapes can be die cut through the finished piece. In between the carrier sheet 1 and the clear sheet 2 are a plurality of transaction cards 4. The carrier sheet may be made of paper or plastic. The transaction cards 4 may be made of paper, plastic, metal, or any other material that is suitable for carrying transaction data. The clear cover sheet 2 may be made from any number of clear resins including Surlyn and polylactic acid. Other thermoplastic ionomer resins or PVC may be used as well. The clear cover sheet may be any thickness but is typically between 0.003″ to 0.010″. The carrier sheet 1 may also have a score line or perforation 16 incised on any edges. This score line defines an easy way for the consumer to peel the securely attached clear cover sheet 2 of the carrier sheet 1.

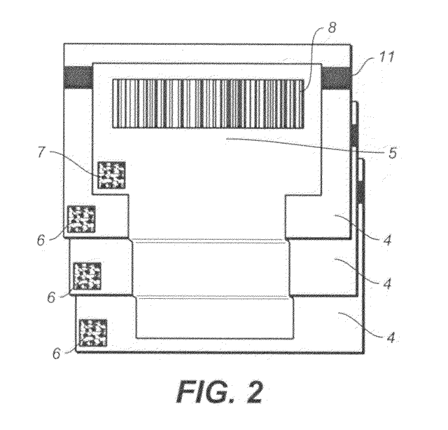

FIG. 2 shows an inner assembly of multiple transaction cards 4 with a card connector 5. The card connector 5 is configured to provide an assembly of cards which is subsequently packaged as shown in FIG. 1. The card connector 5 may include an adhesive that is used to hold the cards 4 on the card connector 5. Such adhesive may for example be a repositionable silicone based adhesive. The card connector 5 permits flexible positioning of the cards for a desired display and/or security arrangement. For example, the cards may be displayed in a manner such that each card is partially or completely visible through the clear cover. The cards may also be positioned in a manner that provides a low profile. Also the arrangement of the cards with the card connector 5 provides improved security because the adhesive connecting the card connector to the cards, which typically has a high shear strength, prevents a card from being removed without applying significant vertical force to separate the card. In the final package side view shown in FIG. 3, the application of the vertical force on any card 4 would pull on the covering film 2. The covering film 2 is selected to have very high resistance to stretching. Thus, pulling on the covering film will tear it loose from the carrier 1 and reveal evidence that tampering has occurred. The adhesive selected for the connecting the cards to the card connector 5 has a much lower peel strength which allows the consumer to easily and conveniently peel the card connector 5 off from the cards 4 and discard it.

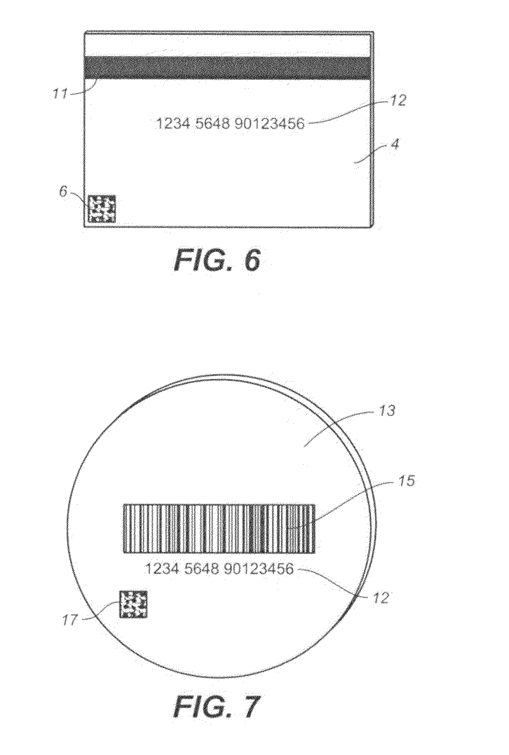

The card connector 5 is encoded with activation identifier 8 and an identification glyph 7 to uniquely identify the card connector 5. The activation identifier is typically an activation bar code formed using a bar code symbology such as a Code 128. The activation identifier may also be a 2-Dimensional bar code such as Data Matrix or human readable text and numbers. The activation identifier is typically scanned or keyed into a point of sales system by a retail clerk in order to activate the cards contained in the package. The transaction cards 4 may be individually personalized with a human readable account number 12, as shown in FIG. 6, an identification glyph 6 and both of which are uniquely matched to the data encoded in the magnetic stripe 11. The card connector 5 can be made from either paper or plastic and according to some embodiments is made in such a way as to accept printing of the activation bar code 8 and the cross reference glyph 7 through any suitable printing means including thermal printing, ink jet, laser printing, ion deposition printing.

During the assembly process a plurality of cards 4 are held in position on the card connector 5 by an adhesive layer. This layer can be coated on the card connector 5 as a pressure sensitive layer or can be applied during assembly as a water based adhesive, hot melt adhesive, or a solvent based adhesive.

Each of the cards 4 in the plurality of cards is associated with a unique account in a database. The activation bar code or account identifier 8 on the card connector 5 may be used to activate all of the accounts associated with each of the transaction cards 4 in the package. To ensure that the proper transactions cards 4 have been assembled with the card connector 5 the individual identification glyphs 6 on each card and the cross reference glyph 7 are machine read and matched against a cross reference database. The cards also have each have separate and unique account numbers printed on them. In this way the packaging integrity of having the correct transaction cards 4 associated with the correct card connecter 5 can be assured.

Any number of transaction cards can be assembled together. FIG. 2 illustrates and exemplary inner assembly of 3 cards. FIG. 3 illustrates an exemplary assembly of 5 cards contained within a package. After the transactions cards 4 are assembled together with the card connector 5 the entire assembly as shown in FIG. 2 is secured to a carrier sheet 2 using a heated clear film as a cover sheet. The film is vacuum formed pulling air through the carrier sheet 2 and through the die cut activation window 9 and the display hanging hole 3. The film flows around the contours of the assembly in FIG. 2 to provide an attractive and secure seal. Other sealing or gluing methods may be used as well.

When additional terms and conditions, usage instructions, or marketing information is required for disclosure to the consumer an alternative embodiment of the invention is shown in FIG. 4 where supplemental brochure 10 is attached to the back of the carrier sheet 1 with fugitive, permanent, or pressure sensitive adhesive 14. The supplemental brochure 10 may also be applied as a pressure sensitive label booklet assembly where a printed and folded paper or plastic sheet is trapped between two layers of pressure sensitive material and the die cut to form a label which can be applied to the back of the carrier sheet 1. Perforations in the outer layer of pressure sensitive material allow the consumer to open and read the folded paper or plastic sheet without removing it from the carrier sheet 1

FIG. 5 shows a perspective view of the back of the package containing the assembly of cards of FIG. 1. The carrier sheet 1 has a die cut window 9 to reveal the activation bar code 8. When the consumer purchases a package, the seller electronically reads the unique activation account number in the activation bar code. The seller then transmits the cost to a transaction processing database where a cross reference table has been built to associate the transaction cards 4 to a specific activation bar code 8. The transaction processing database then activates the accounts associated with the transaction cards and credits them with a designated amount. As the consumer uses the transaction card, this account is debited until there is no remaining balance. The consumer can use the score line 16 to easily separate the clear cover sheet 2 from the carrier sheet 1.

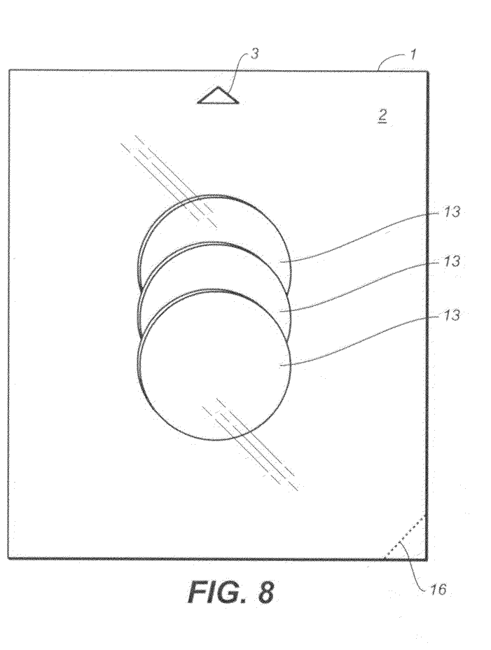

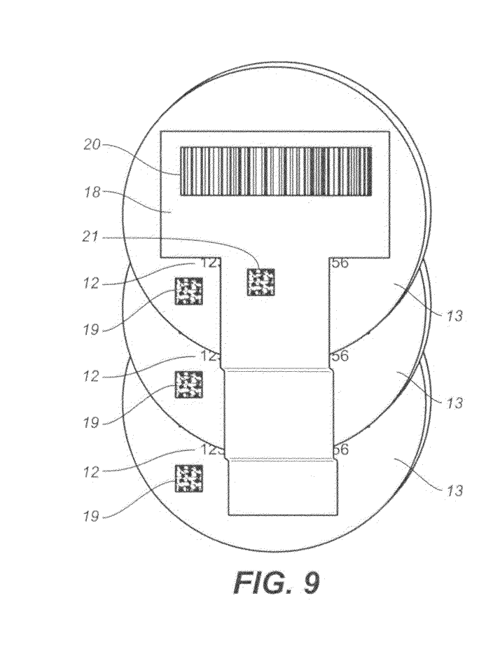

The assembly, method and systems according to some embodiments are well suited to packaging pluralities of transaction cards such as transaction card 4 shown in FIG. 6. These cards are typically rectangular in shape (but may be other shapes) and have optionally a magnetic stripe 11 and are printed with an account number 12. The size and specifications of such cards are described, for example, in ISO 7810 and 7811. Alternative embodiments may include transaction cards not conforming to these specifications. The round transaction card 13 shown in FIG. 9 uses a bar code account number 15 to contain account number 12 information. The alternatively shaped cards may be of different thicknesses, materials, shapes. The alternatively shaped cards may be, for example, be transactions cards with electronic components that generate sound or light when the consumer interacts with the card by pressing a switch imposed on its surface. The transaction card may also have additional planar surfaces that have been movably attached to the surface with a rivet or other type of fastener. The bar code account number 15 is used by the consumer to access the value in the account when making transaction with this alternatively shaped transaction card 13. In the embodiment of the current invention suitable for these cards, the identification glyph 17 is imaged on the card at the same time as the account number bar code. A plurality of alternatively shaped cards is shown in a front view of the alternative embodiment in FIG. 8.

FIG. 9 shows the assembly of the alternative shaped cards 13 of FIG. 7 using an alternatively shaped card connector 18. The card connector is shaped and die cut to allow a identification glyph 19 to be revealed on each of the alternative shaped cards 13. The alternative shaped card connector 18 has an activation bar code 20 printed on it and a cross reference glyph 21. After the plurality of cards is assembled with the card connector the cross reference glyph 21 and the identification bar code 20 and machine read and compared to a database to ensure the correct cards are associated with the correct card connector. The assembly shown is FIG. 9 is then packaged as shown in FIG. 8 with a clear cover sheet 2 and a carrier sheet 1. In some embodiments of the invention with alternatively shaped cards a supplemental brochure would be affixed to the back of the carrier sheet 1 as shown in FIG. 4.

The transaction cards 4, 13 show in FIGS. 1 and 7 respectively can carry the identical account information or each can be unique.

In accordance with some embodiments, a finished skinned package is provided with a one or more of assemblies inside. Such assembly may comprise plurality of transactions cards with a card connector. Such cards may include one or more types of cards including but not limited to standard or common cards, alternatively shaped or configured cards, cards with bar codes, glyphs, readable strips or a combination thereof, multiple packs of cards, staggered multiple cards, and/or cards in a stacked configuration.

A finished package may also comprise a blister pack as an alternative to a skin pack.

The embodiment of the assembly shown in FIG. 2 has three transaction cards in a staggered orientation secured by a pressure sensitive card connector. In other embodiments of the assembly the transaction cards may be stacked directly on top of one another. In still other embodiments of the assembly the transactions cards may have cards oriented in a fanned pattern. In all embodiments a card connector is used to securely hold the transaction cards into position during packaging.

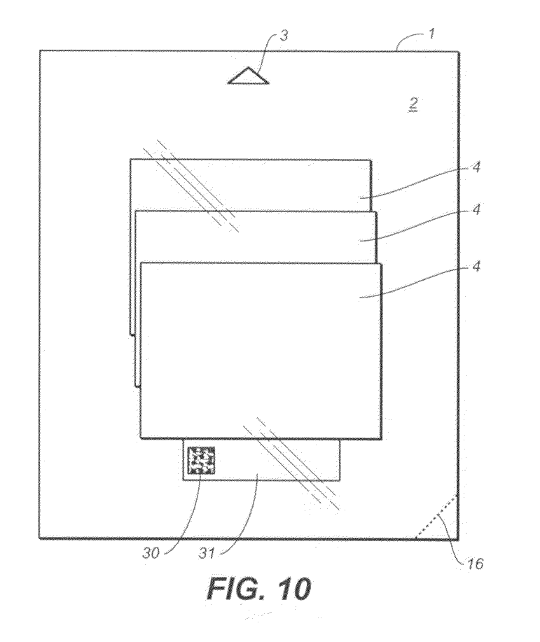

FIG. 10 illustrates a package and card assembly in accordance with some embodiments. The card carrier 5 includes a portion 31 that extends past the cards 4 so that account identifier 30 on the front face or surface of the portion 31 is visible or readable through clear cover 2. This account identifier 31 may be in lieu of or in addition to account identifier 8.

The card connector 5 provides important advantages over other methods of securing cards in a package. The card connector allows all of the data from the transaction cards 4 to be protected from exposure through the die cut window. In addition, the card connector is printed with a machine readable 2D bar code or cross reference glyph 7. This can be read at the same time as the identification glyphs 6 on every one of the transaction cards 4 attached to the connector to ensure that precisely the correct unique transaction cards 4 and unique card connector 5 have been assembled together. The adhesive used to adhere the card connector must allow the card connector 5 to be easily removed without damaging the surface of the transaction cards 4 yet strong enough to hold the transaction cards in the proper orientation during assembly.

In one embodiment the card connector is a paper or plastic substrate with a coating of pressure sensitive adhesive applied, in a thin layer. The transaction cards are held securely while the card connector is impressed onto the back of the transactions cards.

In another embodiment a fugitive hot melt adhesive is applied to the transactions cards first after which the card connector is impressed upon the adhesive securing the transactions cards and card connector together to form the assembly.

The card connector may be printed with machine readable information or human readable text either before it is assembled or after it is assembled to the transaction cards

In accordance with another aspect of the invention, the carrier sheet may have a writable magnetic stripe. A cross reference bar code or glyph may be read from the card connector, used to look up magnetic stripe data and then that data is encoded onto the carrier sheet magnetic stripe. The transaction cards inside the package could be activated by either by scanning the activation bar code or swiping the magnetic stripe on the carrier sheet depending on point of sale activation equipment available.

While the exemplary embodiments of this invention have been illustrated and described, it should be understood that various changes, adaptations, and modifications may be made therein without departing from the spirit of the invention and the scope of any claims hereto.

1. A packaged card assembly comprising:
a plurality of transaction cards;
a card connector coupling said cards to provide an assembly of said cards, said card connector comprising an account activation identifier;
a package comprising:
a carrier portion and a substantially transparent cover portion wherein the card assembly is positioned between the substantially transparent cover portion and the carrier portion, wherein the substantially transparent cover portion and the carrier portion are sealed to contain the assembly therebetween; wherein the carrier portion further comprises a window portion through which the account activation identifier is readable to activate at least one account corresponding to at least one of the plurality of transaction cards.

2. The packaged card assembly of claim 1 wherein the window comprises a cut out of the carrier portion.

3. The packaged card assembly of claim 1 wherein the account activation identifier comprises a bar code.

4. The packaged card assembly of claim 1 wherein each of the transaction cards further comprises a readable card identifier correlated to said account activation identifier.

5. The packaged card assembly of claim 1 wherein each of the plurality of transaction account corresponds to a unique one of a plurality of accounts, and wherein the account activation identifier is readable to activate the plurality of accounts.

6. The packaged assembly card of claim 1 wherein the substantially transparent cover comprises a thermoplastic ionomer resin.

7. The packaged assembly card of claim 1 wherein the substantially transparent cover comprises PLA.

8. A method of packaging and activating a plurality of transaction cards comprising:
providing an assembly of transaction cards coupled to a card connector having an account activation identifier thereon;
providing a card carrier with a window;
positioning the assembly of cards so that the account activation identifier is readable through the window of the card carrier; and
providing a substantially transparent cover and sealing the assembly of transaction cards between the card carrier and the cover.

9. The method of claim 8 further comprising the step of reading the account activation identifier to activate a plurality of accounts associated with the plurality of transaction cards.

10. A packaged card assembly comprising:
a plurality of transaction cards;
a card connector coupling said cards to provide an assembly of said cards, said card connector comprising an account activation identifier;
a package comprising:
a carrier portion and a substantially transparent cover portion wherein the card assembly is positioned between the substantially transparent cover portion and the carrier portion, wherein the substantially transparent cover portion and the carrier portion are sealed to contain the assembly therebetween; wherein the account activation identifier is readable through the substantially transparent cover to activate at least one account corresponding to at least one of the plurality of transaction cards.

11. The packaged card assembly of claim 10 wherein the account activation identifier comprises a bar code.

12. The packaged card assembly of claim 10 wherein each of the transaction cards further comprises a readable card identifier correlated to said account activation identifier.

13. The packaged card assembly of claim 10 wherein each of the plurality of transaction account corresponds to a unique one of a plurality of accounts, and wherein the account activation identifier is readable to activate the plurality of accounts.

14. The packaged assembly card of claim 10 wherein the substantially transparent cover comprises a thermoplastic ionomer resin.

15. The packaged assembly card of claim 10 wherein the substantially transparent cover comprises PLA.
